(19) United States
(12) Patent Application Publication
(10) Pub. No.: US 2009/0018941 A1
(43) Pub. Date: Jan. 15, 2009

(54) EQUITY HOLDER LAND TRUST BUSINESS METHOD

(76) Inventor: Bill J. Gatten, Westhills, CA (US)

Correspondence Address: THORPE NORTH & WESTERN, LLP., P.O. Box 1219, SANDY, UT, 84091-1219, US

(21) Appl. No.: 12/142,941

(22) Filed: Jun. 20, 2008

Related U.S. Application Data
(60) Provisional application No. 60/936,770, filed on Jun. 22, 2007.

(51) Int. Cl. G06Q 40/00

(52) U.S. Cl. 705/35

(57) ABSTRACT

A method for transferring real property ownership includes locating real property having an identified owner. A non exclusive purchase option is prepared to acquire interest in a land trust associated with the real property when predetermined conditions are satisfied. An offer is presented to the owner including an agreement for an investor to assume responsibility for the real property, and the purchase option for the real property in exchange for the owner establishing a revocable inter-vivos land trust associated with the real property and naming the investor as a remainder agent and co-beneficiary to the trust. A qualified independent 3^{rd} party that meets the not-for-profit requirements of U.S. Internal Revenue Code 26 U.S.C. § 501(c) is nominated as a trustee of the trust. A limited and revocable power of attorney is executed that gives the investor co-beneficiary limited power over property management for the real property.

### PRIORITY CLAIM

Benefit is claimed of U.S. Provisional Patent Application No. 60/936,770, Jun. 22, 2007, which is herein incorporated by reference in its entirety for all purposes.

### BACKGROUND OF THE INVENTION

1. Field of the Invention

The present invention relates generally to business methods for conveying real estate ownership between parties.

2. Related Art

Ownership of real property, such as homes, condominiums, tenements, land, and the like is often viewed as the paramount indicator of wealth and success. Indeed, there are many tangible and intangible benefits to owning real estate. For example, some of the benefits of real estate ownership include benefit from a deep sense of security and pride because the owner can make improvements to the property, which may add convenience and value to the property over a period of years. Landowners or homeowners may also deduct mortgage interest and property taxes as an expense against income, while residential investors may write off cost recovery or depreciation. Additionally, real estate values generally tend to rise over a period of years making investment in real property a practical investment strategy. Moreover, real estate can usually be sold at a predicable price to a dependable group of available buyers with time and exposure securing a land owner's return on investment. In fact, many lenders see real estate as a low risk, durable and marketable asset and are willing to loan a high percentage of the property's value.

Unfortunately, entering and leaving the real property market is usually a complex process that is fraught with potential risks. A person trying to buy a home, for instance, generally does not have the financial resources necessary to purchase the property outright. Instead, most people must seek secured financing, such as a mortgage, in order to “buy” their homes. Mortgages, however, usually require the buyer/borrower to provide significant down payments and expensive administrative fees called closing costs. In fact many people are unnecessarily precluded from home ownership because these costs are too high.

Similarly, selling real property can be complex and risky. Sellers are often faced with a need to sell property quickly due to adverse personal financial conditions, job transfers, and the like. Unfortunately, selling real estate often takes some time depending on real estate market conditions such as the availability of qualified buyers, the supply of available properties, and the like. Consequently, sellers often have to hire expensive real estate agents to help market and sell their property. Thus, conveying title of real property between buyers and sellers is usually difficult and expensive for both the buyer and the seller.

### SUMMARY OF THE INVENTION

It has been recognized that it would be advantageous to develop a business method for conveying or transferring ownership of real property between parties that reduces or eliminates expensive down payments and/or mortgaging closing costs. Additionally, it has been recognized that it would be advantageous to develop a business method to convey or transfer ownership of real property between parties that provides quick relief to the seller from ownership upkeep and financial burdens and reduces or eliminates expensive real estate agent commissions.

The invention provides for a method for transferring real property ownership including locating real property having an identified owner. A non-exclusive purchase option can be prepared to acquire interest in a land trust associated with the real property when predetermined conditions are satisfied. An offer can be presented to the owner including an agreement for an investor to assume responsibility for the real property and all payments for, and improvements on, the real property, and the purchase option for the real property in exchange for the owner establishing a revocable inter-vivos land trust associated with the real property and naming the investor as a remainder agent and co-beneficiary to the trust and facilitating access to tax incentives by the investor co-beneficiary. A qualified independent 3^{rd} party organization, such as a not-for-profit corporation can be nominated as a trustee of the trust and a certification of trustee can be executed declaring that the trust associated with the land is in full force and the not-for-profit corporation as trustee. The qualified not-for-profit organization can be an organization that meets the requirements of United States Internal Revenue Code 26 U.S.C. § 501(c) for tax exempt status. A limited and revocable power of attorney can be executed to give the investor co-beneficiary limited power over matters of property management for the real property.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart illustrating a method for transferring real property ownership in accordance with an embodiment of the present invention;

FIG. 2 is a flow chart illustrating a method for transferring real property ownership in accordance with another embodiment of the present invention;

FIG. 3 is a flow chart illustrating a method for transferring real property ownership in accordance with another embodiment of the present invention; and

FIG. 4 is a flow chart illustrating a method for transferring real property ownership in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In describing and claiming the present invention, the following terminology will be used.

The singular forms “a,” “an,” and “the” include plural referents unless the context clearly dictates otherwise. Thus, for example, reference to “a 3^{rd} party co-beneficiary” includes reference to one or more of such 3^{rd} party co-beneficiaries, and reference to “trustee” includes reference to one or more of such trustees.

As used herein, the term “owner” refers to the “owner of record” of a piece of real property that may be placed into a revocable inter-vivos trust. The owner may also be known as the settlor, trustor, or grantor. Additionally, the owner of record who places real property into a land trust may be referred to as the first beneficiary or a settlor beneficiary of the trust. Accordingly, the terms “owner”, “owner of record”, “settlor”, “trustor”, “grantor”, “first beneficiary”, and “settlor beneficiary” may be used interchangeably herein.

As used herein, the term “investor” refers to a party willing to assume fiduciary responsibility for real property and improvements thereon that has been placed into a land trust in exchange for being named a second co-beneficiary to the land trust. Accordingly, the terms “investor”, “investor beneficiary”, “investor co-beneficiary”, “second beneficiary” and “second co-beneficiary” may be used interchangeably herein.

As used herein, the term “resident” refers to a party willing to take up residency in real estate placed into a land trust in exchange for being named a third beneficiary to the land trust. Accordingly, the terms resident”, “resident beneficiary”, “third beneficiary”, “third co-beneficiary”, “3^{rd} party beneficiary”, and “3^{rd} party co-beneficiary” may be used interchangeably herein.

As used herein, the term “real property” refers to real estate, such as a parcel of land, apartment, condominium, and the like, that may be placed into a land trust. Such real property may become the property vested in the trustee. In this way, the reap property may become the corpus or res of the trust. Accordingly, the terms “real property”, “real estate”, “parcel of land”, “corpus”, and “res” may be used interchangeably herein.

The embodiments of the present invention described herein generally provide for a method for conveying or transferring ownership of real property between parties. The method includes a would-be “seller” placing their property into a beneficiary directed, title-holding (Illinois-type) land trust with a third-party trustee. A co-beneficiary interest in the trust can then be assigned to a would-be “buyer”, such as a real estate investor, or a prospective homeowner. Advantageously, an assignment, as opposed to a sale or transfer of the property's legal or equitable title, shields the property from all forms of attack by creditors or by dissent among beneficiaries since legal and equitable title to the property is vested in a bona fide third-party nominee trustee for the shielding of the property and for the mutual benefit and protection of all parties. In a completely separate action, in order to gain possession and income tax deduction benefits the assignee (now a bona fide remainder agent and co-beneficiary), leases the property from the trust on a “triple-net lease” basis. For purposes of this application a “triple net lease” refers to a lease that contains a contractual obligation to pay all costs of ownership and possession, such as interest, property tax, insurance, and the like. In this way, the assignee/co-beneficiary can successfully obtain virtually all the benefits of ownership of the real property including excellent asset protection relative to avoidance of creditor claims and even income tax liens.

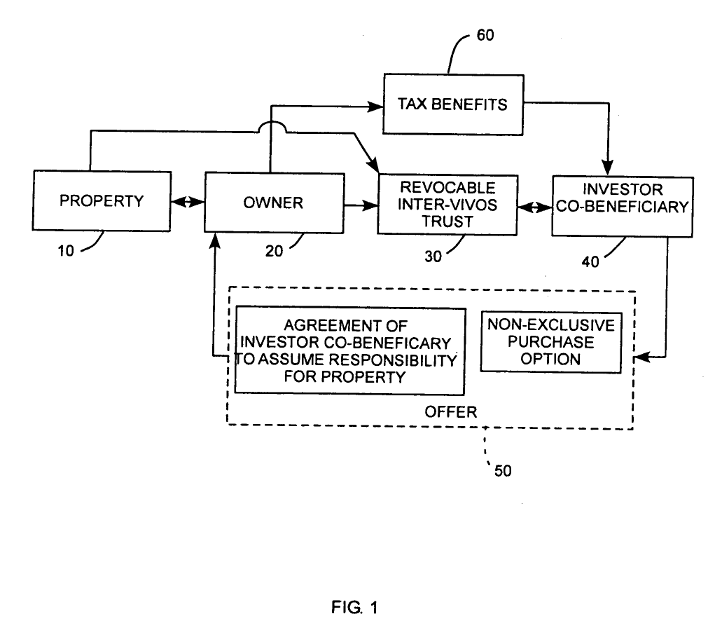

As illustrated in FIG. 1, title for a piece of real property 10 having an owner 20 can be placed in a revocable inter-vivos trust 30 by the owner. An investor 40, such as a prospective purchaser or investment entity, can then make an offer 50 to the owner 20 in which the investor agrees to assume responsibility for the property and any improvements contained thereon. The offer can also include a purchase option, or “first right to buy” option-agreement, wherein the investor agrees to, or is given the right to purchase the property from the owner's nominated trustee at termination when certain predetermined conditions are met. In exchange, the owner agrees in advance to allow tax benefits 60 related to the property to be accessed by the investor, by making the investor a co-beneficiary to the trust. Additionally, the investor can have a part in naming the trustee to the trust. In this way, the legal and equitable title of the property can be given to a trustee (as opposed to the trust arrangement itself) while the investor co-beneficiary has personal property rights in the land trust arrangement. In this way, the investor co-beneficiary can be a “resident” beneficiary, and can access virtually all of the benefits of Fee Simple ownership including: tax credits and deductions; proceeds from any sale of the property; and responsibility and control of the property as a co-director of the trustee owner.

Thus, the present invention provides several advantages to the owner and investor co-beneficiaries not normally realized in a typical land transaction. For example, in spite of a relinquishment of ownership of realty (by the process of the Doctrine of Equitable Conversion), whereby ownership of realty is converted to ownership of personalty, the IRS (IRC § 163(h)4(D)) insists that beneficiaries of land trusts, with at least a 10% interest, must be treated for all tax purposes as owners of the realty held by the trust (i.e., the IRS looks “through” the land trust, not a “pass-through” entity, but as a “see-through” entity in the eyes of the IRS). This means that the investor co-beneficiary has full access to income tax write-offs, such as IRC § 1031 exchange, and IRC § 121 exclusions with respect to the sale of a personal residence.

It will be appreciated that these tax benefits cannot be sold, gifted or assigned, but instead, they are taken by the resident beneficiary solely because doing so is allowed under IRC § 163(h)4(D) and Internal Revenue Rule 92-105. Accordingly, there need be no agreement of any kind between parties relative to tax deductions provided the parties are entitled to them. This applies to both resident and non-resident parties. A non-resident party could take the same write-off to use it to offset income and pay tax only on positive cash flow received. However, if the income is not received, and only a positive cash flow is derived, then that party still only pays tax on the positive cash flow.

As another advantage, the investor co-beneficiaries get all of the benefits of fee simple real estate ownership plus the asset protection of the property again liens, lawsuits, bankruptcy, actions in marital dissolution, probate proceedings, ancillary administration, reversionary penalties, etc. Furthermore, the property in a co-beneficiary and trust (assuming the beneficiaries are unrelated) is protected against the necessity of foreclosure, ejectment and quiet to cure a default by a “tenant buyer” because the investor co-beneficiary, or resident beneficiary is never an owner of the property, but only a beneficiary in the trust that owns the property. As such, the investor co-beneficiary, or resident beneficiary is only leasing, although with full income tax benefits.

As another advantage, the trust arrangement can be carefully drawn and balanced to prevent the transaction from being characterized as a disguised security agreement, and equitable mortgage, a corporation or partnership.

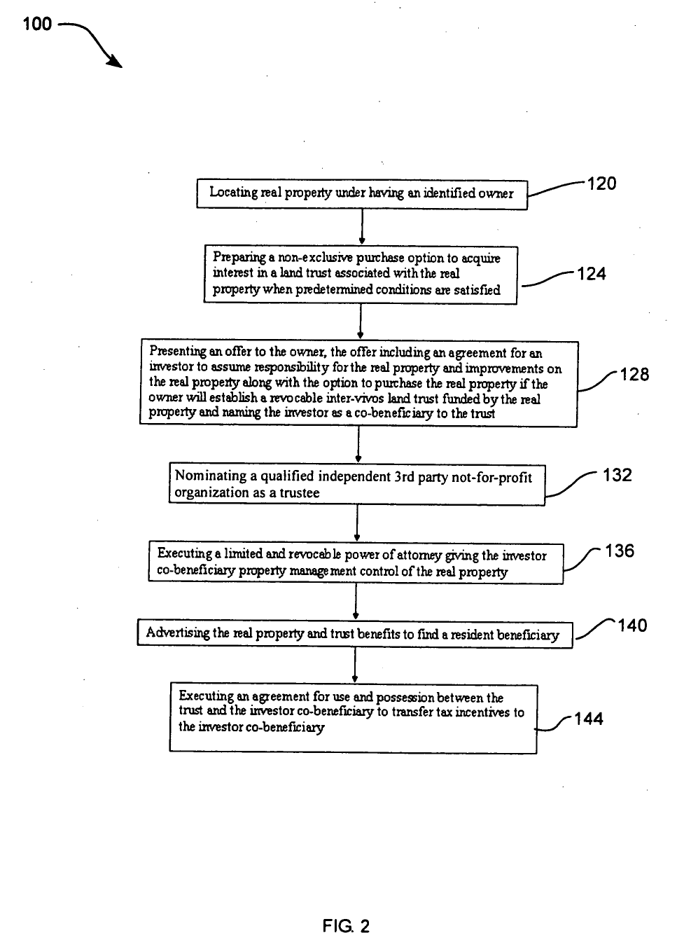

This structure can be implemented by the methodology as illustrated in FIG. 2, which shows a method for transferring real property ownership, indicated generally at 100, in accordance with an embodiment of the present invention. The method includes locating real property having an identified owner, as shown at 120. A non-exclusive purchase option can be prepared to acquire interest in a land trust associated with the real property when predetermined conditions are satisfied, as shown at 124. An offer can be presented to the owner, as shown at 128. The offer can include an agreement for an investor to assume responsibility for the real property and all payments for, and improvements on, the real property, and the purchase option 124 for the real property in exchange for the owner establishing a revocable inter-vivos land trust associated with the real property and naming the investor as a remainder agent and co-beneficiary to the trust and facilitating access to tax incentives by the investor co-beneficiary.

A qualified independent 3^{rd} party organization, such as a not-for-profit corporation can be nominated as a trustee of the trust and a certification of trustee can be executed declaring that the trust associated with the land is in full force and the not-for-profit corporation as trustee, as shown at 132. In one aspect, the qualified not-for-profit organization may meet the requirements of United States Internal Revenue Code 26 U.S.C. § 501(c) for tax exempt status.

It will be appreciated that the land trust beneficiary, or investor co-beneficiary is not the 3^{rd} party trustee, since such an arrangement would constitute a merger of title, thereby weakening the legal structure of the arrangement. The trustee should always be an independent third-party. Thus, for example, the trustee can be a corporation, such as a bank and trust, title and trust, or a non-profit 501-C corporation acting for the benefit of its members.

A limited and revocable power of attorney can be executed to give the investor co-beneficiary limited power over matters of property management for the real property, as shown at 136. Additionally, the real property and trust benefits can be advertised to find a resident beneficiary, as shown at 140. An agreement for use and possession can also be executed between the trust and the investor co-beneficiary to transfer tax benefits associated with the property to the investor co-beneficiary, as shown at 144.

The method can also include recording the purchase option, certification of trustee, and power of attorney with an appropriate government representative. Additionally, the method can include executing a notification of uninsured deed.

Thus, in general, the method for transferring ownership described herein can create a title-holding device that allows for easy conveyance of ownership, and incidents of ownership (including tax write-off benefits). The method establishes an arrangement wherein a 3rd party trustee holds title to the property; however, actions in dealing with the property's title are wholly at the direction of the beneficiaries. Additionally, all or a portion of the beneficial interest in the property can then be transferred to a co-beneficiary and the beneficiary interest held by the co-beneficiary can be sold, traded, transferred or hypothecated by means of a simple assignment of beneficiary interest. Because the property is placed into a revocable trust the method does not impinge the lender's security interest, and thus the permission of the lender or the secured party in the underlying mortgage loan is not required to transfer the beneficial interest.

Advantageously, investors may utilize the method for transferring ownership described herein in various ways. For example, anytime a seller is willing to remain on the existing financing (keep their names on the loan), the method can provide an ideal vehicle for acquiring the property conveniently and anonymously. That is, the ownership of the property can be transferred easily, quickly and without Public Notice, such as by recording, as well as without the potential for the triggering of a mortgage lender's Due on Sale provision. In fact, the method of the present invention tends to effectively protect the property against liens, suits, creditor judgments, and even IRS tax liens on behalf of either party. Also avoided is the necessity for dangerous or marginally unethical creative financing schemes. Without the necessity of subterfuge or deceit with respect to a lender's security interest in the property, the method of the present invention becomes an ideal acquisition vehicle.

Moreover, the method for transferring ownership described herein may be seen an effective legal shield for many creative financing methods. It can, in essence be tantamount to a Long Term Lease (i.e., a lease for more than 3 years); a Lease Option; a Lease Purchase, an All Inclusive Trust Deed, an Equity Share Arrangement, or a Land Contract (e.g., Contract for Sale, Contract for Deed, Contract for Warranty Deed, etc.). Advantageously, the method of the present invention can meet the objectives and functions of any of these arrangements while reducing the many risks associated with them.

Thus, as noted above, the method for transferring ownership described herein can be used to facilitate a long term lease that can be set up for up to twenty years, with a corresponding lease of the property to a resident co-beneficiary for up to 2 years, eleven months and twenty-nine days. The lease with the trust can stipulate that at the end of the original lease term, the tenant (i.e. the resident co-beneficiary) may “hold-over” in the property until the end of the trust period, unless evicted sooner. Since an eviction would have to be by mutual direction by ALL beneficiaries, and the tenant is one of the beneficiaries, the tenant is protected by the trust and effectively continues his/her holdover until the termination of the trust.

In another aspect, the method for transferring ownership described herein can be used as an All Inclusive Trust Deed or Wrap-Around deed. For example, a seller can place its property into a trust and assign a full beneficiary interest to the “buyer,” with the agreement that the property will be leased to the co-beneficiary on a Triple-Net basis for some specified period of time. The property can then be scheduled to be sold at the end of the Agreement. Upon sale there can be a distribution of proceeds to or between the parties with respect to each and their proportionate shares of beneficiary interest. In order to avoid reassessment for property tax purposes, and to justify mutual power of direction, the shares of beneficiary interest can remain at about 90% in favor of the “buyer” with about 10% remaining with the “seller”. Then at the end of the term, the “seller” can forfeit its 10% in consideration of the co-beneficiary's (buyer) prompt payment record and strict adherence to the contract.

In yet another aspect, the method for transferring ownership described herein can be used as a lease option. For example, the property can placed into a trust with the understanding that, at the end of the agreement, the property will be sold to the resident co-beneficiary for fair market value, minus any and all sums owed to the resident co-beneficiary. In this aspect, verbiage in the contractual documentation can be such that there is actually no “option” per se; and that there is no “bargain buy-out” provision other than “ . . . at Fair Market Value, less amounts due the respective beneficiaries.”

In yet another aspect, the method for transferring ownership described herein can be used as a lease purchase. In this aspect, the agreement can provide that the property will be acquired by the resident beneficiary at termination irrespective of market conditions, relative values, etc. This provision or “rider” can provide that the co-beneficiary has the obligation either to sell or refinance at termination of the agreement.

In yet another aspect, the method for transferring ownership described herein can be used as an equity share. In this aspect, the parties share 50:50 in the beneficiary interest with an agreement to share all net profits proportionately at termination of the agreement.

In yet another aspect, the method for transferring ownership described herein can be used as a bridge-loan device. A bridge-loan is used when a buyer can't finance, or afford a down payment for several more months or years and the seller may be willing to wait awhile. Thus, in this aspect, the method of the present invention provides buyer the opportunity to live in the property, while paying all costs and enjoying all the benefits and incidents of homeownership, including tax write-off and waiting until financing and outright purchase is possible at a later time. In this aspect, the trust can be set up to coincide with that point in time when the property can be purchased outright by the resident beneficiary.

In yet another aspect, the method for transferring ownership described herein can be used as a vehicle for higher rents and freedom from active landlord responsibilities and costs. For example, a method of the present invention allows a landlord to trade such items as tax write-offs, equity, equity build-up, appreciation and the psychological peace of homeownership, for such commodities as free maintenance, repairs, upkeep, management, and relatively higher rents. Each one of these “items of trade” has a value, and giving up all or some of each one can more than double rents while simultaneously reducing the expense of renting for the tenant.

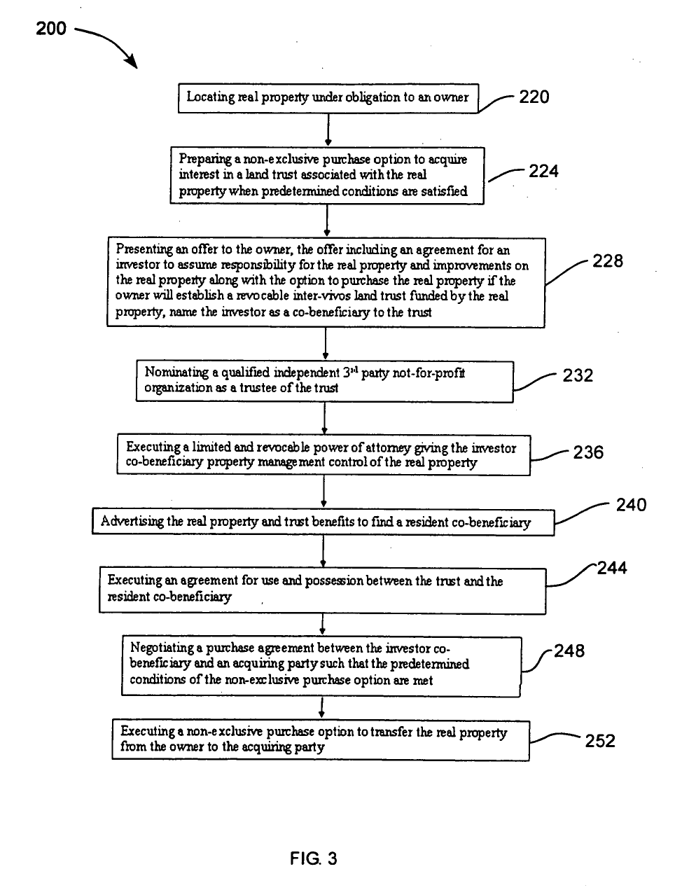

As illustrated in FIG. 3, a method for transferring real property ownership, indicated generally at 200, is shown in accordance with another embodiment of the present invention. The method 200 can be similar in many respects to the method 100 described above and shown in FIG. 2. Thus, the method can include locating real property having an identified owner, as shown at 220. A non exclusive purchase option can be prepared to acquire interest in a land trust associated with the real property when predetermined conditions are satisfied, as shown at 224. An offer can be presented to the owner, as shown at 228. The offer can include an agreement for a investor to assume responsibility for the real property and improvements on the real property, and the purchase option 224 for the real property in exchange for the owner establishing a revocable inter-vivos land trust associated with the real property and naming the investor as a co-beneficiary to the trust, thereby allowing the investor co-beneficiary to claim and exercise tax incentives, such as tax credits, deductions, depreciation, and the like. A qualified independent 3^{rd} party organization, such as a not-for-profit corporation can be nominated as a trustee of the trust and a certification of trustee can be executed declaring that the trust associated with the land is in full force and the not-for-profit corporation as trustee, as shown at 132. A limited and revocable power of attorney can be executed to give the investor co-beneficiary managerial control of the real property, as shown at 236. The real property and trust benefits can be advertised to find a resident co-beneficiary, as shown at 240. An agreement for use and possession can be executed between the trust and the resident co-beneficiary to transfer tax benefits to the resident co-beneficiary, as shown at 244.

The method can also include negotiating a purchase agreement between the investor co-beneficiary and an acquiring party such that the predetermined conditions of the non-exclusive purchase option are met, as shown at 248. The acquiring party can be an investment entity such as a real estate investment group, an individual, a corporation, and the like. Additionally, the non-exclusive purchase option can be executed to transfer the real property from the owner to the acquiring party, as shown in at 252.

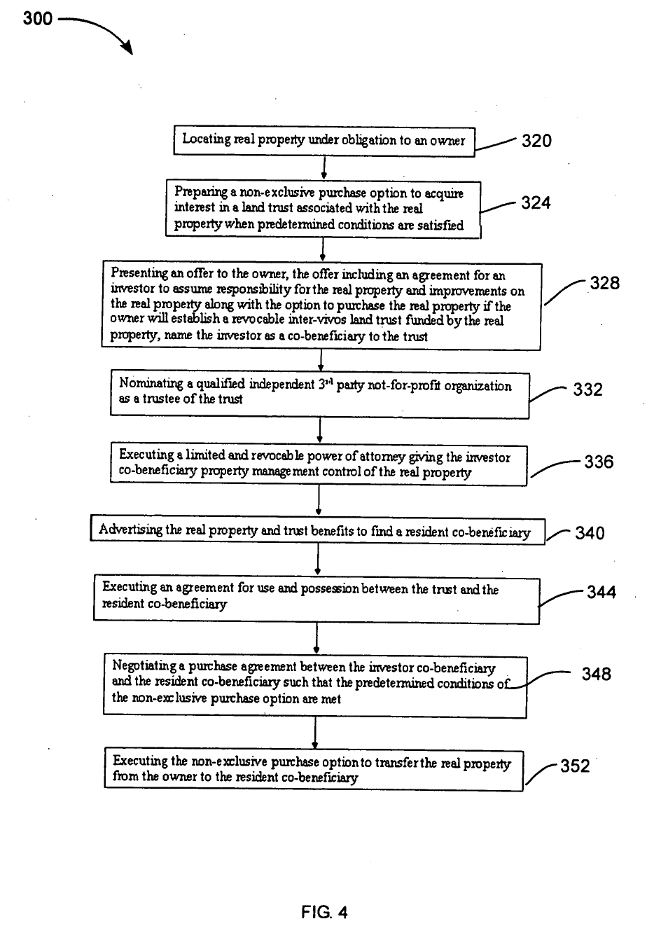

As illustrated in FIG. 4, a method for transferring real property ownership, indicated generally at 300, is shown in accordance with another embodiment of the present invention. The method 300 can be similar in many respects to the method 100 described above and shown in FIG. 2. Thus, the method can include locating real property having an identified owner, as shown at 20. A non exclusive purchase option can be prepared to acquire interest in a land trust associated with the real property when predetermined conditions are satisfied, as shown at 324. An offer can be presented to the owner, as shown at 328. The offer can include an agreement for a investor to assume responsibility for the real property and improvements on the real property, and the purchase option 324 for the real property in exchange for the owner establishing a revocable inter-vivos land trust associated with the real property and naming the investor as a co-beneficiary to the trust and relinquishing tax incentives to the investor co-beneficiary. A qualified independent 3^{rd} party organization, such as a not-for-profit corporation can be nominated as a trustee of the trust and a certification of trustee can be executed declaring that the trust associated with the land is in full force and the not-for-profit corporation as trustee, as shown at 132. A limited and revocable power of attorney can be executed to give the investor co-beneficiary management control of the real property, as shown at 336. The real property and trust benefits can be advertised to find a resident co-beneficiary, as shown at 340. An agreement for use and possession can be executed between the trust and the resident co-beneficiary to transfer tax incentives to the resident co-beneficiary, as shown at 344.

The method can also include negotiating a purchase agreement between the investor co-beneficiary and the resident co-beneficiary such that the predetermined conditions of the non-exclusive purchase option are met, as shown at 348. Additionally, the non-exclusive purchase option can be executed to transfer the title of the real property from the owner to the resident co-beneficiary, as shown at 352.

In summary, the embodiments of the present invention described herein generally provide for a prospective acquiring party, such as an investor or hopeful resident beneficiary/tenant buyer seeking out a prospective seller of real property who is motivated to leave existing mortgage financing in place. The prospective seller places the real property into a land trust, such as an Illinois type land trust, and consents to leaving some or all of the property's existing equity, if applicable, in tact until the land trust terminates on a mutually agreed-upon date. Advantageously, this allows the acquiring party to take the property over without much expenditure up front and without standard credit qualification requirements.

When the motivated seller and property are found, the acquiring party obtains control of the property by having the prospective seller execute a non-exclusive short-term (30-60 days) non-exclusive purchase option with the acquiring party. This option can be cancelled at any time by the optionor with a 5 or 10 days notice to the optionee if a better offer is received, thus, giving the optionee notice for quick action or relinquishment of control. When the option arrangement is accepted, following due diligence by the acquiring party, the option is exercised and all documentation for transfer to the trustee and the assignment of beneficiary interest is prepared and executed by all parties.

Once the resident beneficiary (if there is to be one in lieu of just leasing or renting the property out) is found, the resident beneficiary moves into the property as a triple-net lessee, leasing from the trust's trustee (not the trust). The lease contract provides that the co-beneficiary will handle all incidents and costs of ownership in exchange for virtually all the benefits of homeownership. Such benefits include: appreciation potential, equity build-up from principal reduction, full tax write-off, use and occupancy, mineral and water rights, quiet enjoyment, merchantability, the right to lease or sublease, the right to modify the premises by permit, and the like, including almost perfect asset protection, with respect to the property, due to its being shielded from public view and the inability of judgment creditors to partition or charge co-owned personalty for debt satisfaction.

Accordingly, the present invention includes the trust being executed by the settler, or motivated seller, who is the only beneficiary of the trust. The trust can be named for the street on the property is located. In recording the deed to the trustee, the name of the trustee comes before the name of the trust, otherwise the record would show the owner to be the trust vs. the trustee.

After the deed to the trustee is recorded, then the Assignment of Beneficiary Interest designating the parties, term of agreement, and the parties respective percentages of ownership is executed. After the Assignment of Beneficiary Interest is executed, the Beneficiary Agreement is drafted and executed which outlines all parties' benefits and responsibilities. After the Assignment of Beneficiary Interest is executed, the Limited and Revocable Power of attorney allowing the attorney in fact to “vote the proxy” of the settler can be executed.

Next, the lease agreement with whoever is designated to live in the property is drafted and executed. Since the tenant can be a beneficiary with the full burden of ownership and an equitable interest in the trust that holds the equitable interest in the corpus, then resident beneficiary is entitled to full tax benefits relative to mortgage interest and property tax. Non-resident beneficiaries are entitled to passive losses such as depreciation.

Other ancillary documentation that can be included in the transaction of the present invention include authorization letters, purchase offer agreements, trustee directions and various certifications.

Thus, the transaction of the present invention advantageously provides for active tax write-off under IRC 163(h)4(D), exchange under Internal Revenue Rule 92-105 section 1031, sale of personal residence under IRC 121. Additionally, the land trust is beneficiary-directed, not ever trustee directed, and legal and equitable title is vested solely in trustee. Beneficiaries hold a personal property interest in the trust only, not the property. Moreover, the trustee is appointed by the beneficiaries and is usually named by the settlor or investor beneficiary prior to identifying a resident beneficiary. The Trustee may not collect payments or make disbursement: all management is done solely by beneficiaries. Beneficiaries may, however, appoint a bill-paying agency who can act without charge.

Additionally, in the event a defaulting tenant beneficiary or resident beneficiary is evicted, such default may constitute constructive notice to the non-defaulting beneficiaries of the defaulting beneficiary's intent to sell the defaulting beneficiaries interest in the trust (wherein no default has taken place) for full fair market value to the non-defaulting beneficiaries. Full fair market value must be determines by the defaulting party by suitable market appraisal, such as a MAI appraisal or the like, following payment of a specified default fee and all associated costs. Should the offer made by the non-defaulting parties be deemed insufficient, the defaulting beneficiary appraises the property as per above, and must be paid the full sum owed, in the form of an unsecured promissory note. The note is then set to be honored in full at or before the scheduled trust termination date, if sufficient funds are derived at that time from such sale. In this way, security can be given to both defaulting beneficiaries and non-defaulting beneficiaries with respect to their prospective interests in the real property.

Additionally, it is a particular advantage of the method of the present invention that the beneficial and co-beneficial interests in the land trust can be used as security in a loan transaction.

In this way, foreclosure remedies normally used against defaulting parties in traditional mortgages can be bypassed such that the beneficial interest can be reposes than having to foreclose on it.

Advantageously, this allows reclaiming of the property in approximately thirty days rather than having to wait out the 6 months for the foreclosure process on a mortgage.

It is to be understood that the above-referenced arrangements are only illustrative of the application for the principles of the present invention. Numerous modifications and alternative arrangements can be devised without departing from the spirit and scope of the present invention.

While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A method for transferring real property ownership, comprising:
a) locating real property having an identified owner;
b) preparing a non exclusive purchase option to acquire interest in a land trust associated with the real property when predetermined conditions are satisfied;
c) presenting an offer to the owner, the offer including:
i) an agreement for an investor to assume responsibility for the real property and improvements on the real property; and
ii) the purchase option for the real property if the owner will establish a revocable inter-vivos land trust associated with the real property and naming the investor as a co-beneficiary to the trust;
d) nominating a qualified not-for-profit organization as trustee of the trust; and
e) executing a limited and revocable power of attorney giving the investor co-beneficiary limited power over matters of property management for the real property.

2. The method of claim 1, wherein the qualified not-for-profit organization meets the requirements of United States Internal Revenue Code 26 U.S.C. § 501(c) for tax exempt status.

3. The method of claim 1, further comprising:
a) executing an agreement for use and possession between the trust and the investor co-beneficiary to enable the investor co-beneficiary to claim tax benefits associated with the property to the investor co-beneficiary.

4. The method of claim 1, further comprising:
a) exercising tax incentives and benefits by all co-beneficiaries according to the share of beneficial interest each co-beneficiary holds in the real property.

5. The method of claim 1, further comprising:
a) recording the purchase option, certification of trustee, and power of attorney with an appropriate government representative.

6. The method of claim 1, further comprising:
a) executing a notification of uninsured deed.

7. The method of claim 1, wherein execution of the trust further includes assigning a relatively larger percentage of the beneficial interest in the property to the investor, and a relatively smaller percentage of the beneficial interest to the owner.

8. The method of claim 1, wherein execution of the trust further includes assigning approximately 50% of the beneficial interest in the property to the investor, and approximately 50% of the beneficial interest to the owner.

9. The method of claim 1, wherein the trust includes provisions that facilitate a transaction selected from the group consisting of a lease option, a lease purchase, an all inclusive trust deed, an equity share arrangement, a land contract, a contract for sale, a contract for deed, a contract for warranty deed, and combinations thereof.

10. The method of claim 1, further comprising advertising the real property and trust benefits to find a resident co-beneficiary.

11. The method of 10, further comprising:
a) negotiating a purchase agreement between the investor co-beneficiary and the resident co-beneficiary such that the predetermined conditions of the non-exclusive purchase option are met; and
b) executing the non-exclusive purchase option to transfer the title of the real property from the owner to the resident co-beneficiary.

12. The method of claim 1, wherein the trustee is granted the rights to title to deal with matters of title on behalf of the beneficiaries of any unpaid monies owned by the beneficiaries of the trust.

13. The method of claim 1, wherein the identified owner is a motivated seller who is willing to leave the seller's existing mortgage financing in place along with some or all of the property's existing equity until the land trust terminates.

14. The method of claim 1, wherein the non-exclusive purchase option is a short term purchase option having a term of between 30 and 60 days and has the option of being cancelled at any time by either party with between 5 and 10 days notice.

15. The method of claim 1, further comprising:
a) using the beneficial and co-beneficial interests in the land trust as security in a loan transaction; and
b) repossessing the beneficial interest within approximately thirty days.

16. A method for transferring real property ownership, comprising:
a) locating real property having an identified to an owner;
b) preparing a non exclusive purchase option to acquire interest in a land trust associate with the real property when predetermined conditions are satisfied;
c) presenting an offer to the owner, the offer including:
i) an agreement for an investor to assume responsibility for the real property and improvements on the real property; and
ii) the purchase option for the real property if the owner will establish a revocable inter-vivos land trust associated with the real property and naming the third party as a co-beneficiary to the trust;
d) nominating a not-for-profit organization meeting the requirements of United States Internal Revenue Code 26 U.S.C. § 501(c) for tax exempt status as trustee of the trust; and
e) executing a limited and revocable power of attorney giving the investor co-beneficiary limited power over matters of property management for the real property;
f) negotiating a purchase agreement between the investor co-beneficiary and an acquiring party such that the predetermined conditions of the non-exclusive purchase option are met; and
g) executing the non-exclusive purchase option to transfer the real property from the owner to the acquiring party.

17. The method of claim 16, wherein the investor co-beneficiary is an investment entity selected from the group consisting of a real estate investment group, an individual, a corporation, and combinations thereof.

18. The method of claim 17, further comprising advertising the real property and trust benefits to find a resident co-beneficiary.

19. The method of claim 18, further comprising:
a) negotiating a purchase agreement between the investor co-beneficiary and the resident co-beneficiary such that the predetermined conditions of the non-exclusive purchase option are met; and
b) executing the non-exclusive purchase option to transfer the title of the real property from the owner to the resident co-beneficiary.

20. A method for transferring real property ownership, comprising:
a) locating real property under obligation to an owner;
b) preparing a non exclusive purchase option to acquire interest in a land trust funded by the real property when predetermined conditions are satisfied;
c) presenting an offer to the owner, the offer including:
i) an agreement for an investor to assume responsibility for the real property and improvements on the real property; and
ii) the purchase option for the real property if the owner will establish a revocable inter-vivos land trust associated with the real property and naming the investor as a co-beneficiary to the trust;
d) nominating a not-for-profit organization meeting the requirements of United States Internal Revenue Code 26 U.S.C. § 501(c) for tax exempt status as trustee of the trust; and
e) executing a limited and revocable power of attorney giving the investor co-beneficiary limited power over matters of property management for the real property.
f) advertising the real property and trust benefits to find a resident co-beneficiary;
g) executing an agreement for use and possession between the trustee and the resident co-beneficiary to allow the resident co-beneficiary to claim tax benefits on the real property.

21. The method of claim 20, further comprising:
a) negotiating a purchase agreement between the investor co-beneficiary and the resident co-beneficiary such that the predetermined conditions of the non-exclusive purchase option are met; and
b) executing the non-exclusive purchase option to transfer the title of the real property from the owner to the resident co-beneficiary.

22. The method of claim 20, further comprising:
a) accepting a default in lease payments by the resident co-beneficiary as constructive notice of the defaulting beneficiary's intent to sell the defaulting beneficiaries interest in the trust for full fair market value to the non-defaulting beneficiaries;
b) determining full fair market value by authorized appraisal; and
c) facilitating an offer by the non-defaulting parties to the defaulting party to purchase the defaulting parties beneficial interest in the trust.

23. The method of claim 22, further comprising:
a) facilitating payment of the difference between the full fair market value and the offer of the non-defaulting parties in the form of an unsecured promissory note set to be honored in full at or before the scheduled trust termination date provided sufficient funds are derived from any sale of the real property at the termination date.

24. The method of claim 20, further comprising:
a) recording the purchase option, certification of trustee, and power of attorney with an appropriate government representative.
